(19) United States
(12) Patent Application Publication
(10) Pub. No.: US 2008/0272884 A1
(43) Pub. Date: Nov. 6, 2008

(54) System and Method for Enhanced Threat Alerting

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 12/111,621

(22) Filed: Apr. 29, 2008

Related U.S. Application Data
(60) Provisional application No. 60/915,786, filed on May 3, 2007.

(51) Int. Cl. G08B 5/22; H04Q 7/00

(52) U.S. Cl. 340/7.61; 340/7.58; 382/100

(57) ABSTRACT

An infrastructure that (1) leverages technology to apply an array of techniques, strategies, capabilities, etc. to, for example, the output of CCTV systems to yield, possibly inter alia, augmented threat identification capabilities and (2) allows mobile subscribers, through their wireless devices, to fully participate in such threat detection mechanisms to provide for, possibly inter alia, enhanced threat alerting capabilities. The infrastructure may optionally leverage the capabilities of a centrally-located Messaging Inter-Carrier Vendor.

This application claims the benefit of U.S. Provisional Patent Application No. 60/915,786, filed on May 3, 2007, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Short Message Service (SMS), Multimedia Message Service (MMS), etc.

2. Background of the Invention

As the ‘wireless revolution’ continues to march forward the importance to a Mobile Subscriber (MS)—for example a user of a Wireless Device (WD) such as a mobile telephone, a BlackBerry, etc. that is serviced by a Wireless Carrier (WC)—of their WD grows substantially.

One consequence of such a growing importance is the resulting ubiquitous nature of WDs—i.e., MSs carry them at almost all times and use them for an ever-increasing range of activities.

Concurrent with the positive progress that the ‘wireless revolution’ has enjoyed society has, sadly, suffered significant negative progress. Among other things we live in an increasingly more dangerous and violent environment—e.g., pervasive street crime, terrorism, domestic violence, gang activities, aggressive drivers, school shootings, home invasions, etc.

One response to our increasingly more dangerous and violent environment has been the installation of surveillance and monitoring systems such as Closed Circuit Television (CCTV)—e.g., city-wide (such as in London), within selected areas of a city (e.g., along a road or a highway, within a shopping area such as a pedestrian mall, etc.), within a facility (such as, for example, a refinery, a manufacturing complex, an office or a college campus, etc.), within a building (such as, for example, an airport, a hospital, an office, a housing facility, a retail establishment, an educational institution, a restaurant, etc.), etc.

The output of CCTV systems (e.g., the images from individual cameras within such systems) have traditionally been monitored by human beings who, possibly inter alia, visually identify a potential threat and then manually raise or issue an appropriate set of alerts.

It would be advantageous to have an infrastructure that (1) leverages technology to apply an array of techniques, strategies, capabilities, etc. to, for example, the output of CCTV systems to yield, possibly inter alia, augmented threat identification capabilities and (2) allows MSs, through their WDs, to fully participate in such threat detection mechanisms to provide for, possibly inter alia, enhanced threat alerting capabilities.

The present invention facilitates such enhanced threat identification and alerting capabilities and addresses various of the (not insubstantial) challenges that are associated with same.

### SUMMARY OF THE INVENTION

In an embodiment of the present there is provided a method for threat alerting, that includes receiving from a mobile subscriber travel pattern information for the mobile subscriber, receiving a stream of images from a camera, determining that the images from the camera depict a location that is within the travel pattern of the mobile subscriber, processing the images from the camera to determine the existence of threatening behavior at the location, and sending an alert message to the mobile subscriber indicating that a threat may exist at the location. The alert message may be in the form of, e.g., an SMS message or an MMS message, among other possibilities.

In accordance with an aspect of the invention, the stream of images is received from a closed circuit television system, and processing of the images may include, among others, facial recognition, person-to-person interaction, body movement, or dress analysis.

In accordance with another aspect of the invention, values representative of the at least one of facial recognition, person-to-person interaction, body movement, or dress analysis may be weighted to obtain a final single result regarding the likelihood of a threat condition.

In addition to the forgoing types of analysis, image processing may further include identifying that a given key or string of keys has been selected. With such information it may be possible to determine if someone is attempting to contact another person, which in and of itself, might give rise to a threat condition.

Still additional information that might inform decision making regarding a threat condition is provided collecting data associated with items within the images from the camera. Such data may include, for example, radio frequency identification (RFIF) data.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates various of the exchanges or interactions that are possible during the registration portion of the present invention.

FIG. 3 illustrates various of the exchanges or interactions that are supported by aspects of the present invention.

FIG. 4 is a diagrammatic presentation of aspects of an exemplary Service Provider (SP) Application Server (AS).

It should be understood that these figures depict embodiments of the invention. Variations of these embodiments will be apparent to persons skilled in the relevant art(s) based on the teachings contained herein.

### DETAILED DESCRIPTION

Aspects of the present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

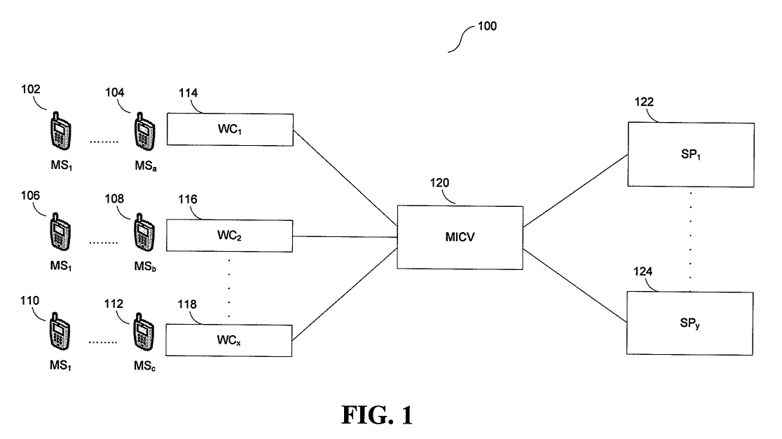

As illustrated in FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, 110→112 that are serviced by the WC 114→118) with ubiquitous access to a broad universe of SPs 122→124, and

2) A SP 122→124 with ubiquitous access to a broad universe of WCs 114→118 (and, by extension, to all of the MSs 102→104, 106→108, 110→112 that are serviced by the WCs 114→118).

Generally speaking a MICV may have varying degrees of visibility (e.g., access, etc.) to the (MS← →MS, MS← →SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV, it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through aspects of the instant invention and Mary, a MS, uses SPₓ's service.

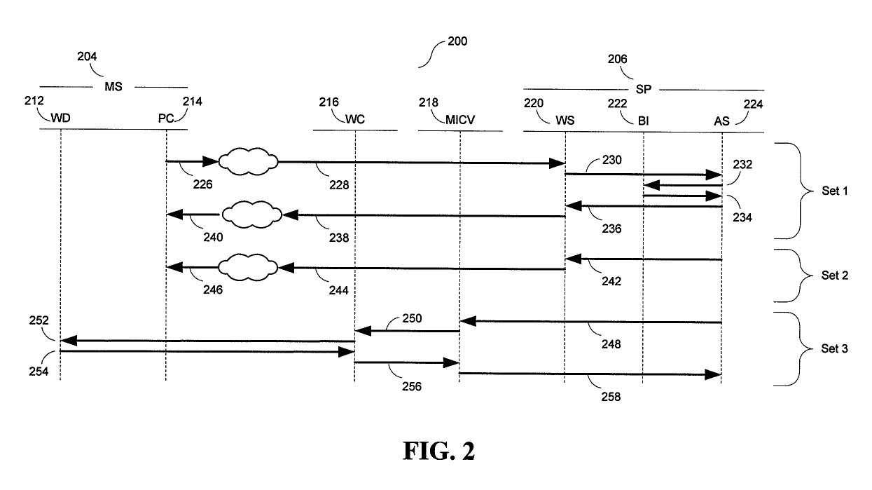

FIG. 2 and reference numeral 200 illustrate various of the exchanges or interactions that might occur under a registration portion of our hypothetical example. A registration process may be tailored (e.g., the range of information gathered, the scope of access subsequently granted, etc.) to the class of user—e.g., different types, categories, etc. of users may complete different registration processes. Of interest and note in the diagram are the following entities:

MS 204 WD 212. For example, Mary's WD such as mobile telephone, BlackBerry, PalmPilot, etc.

MS 204 Personal Computer (PC) 214. For example, one of Mary's 204 home, work, etc. PCs.

WC 216. The provider of service for Mary's 204 WD 212.

MICV 218. As noted above the use of a MICV, although not required, provides significant advantages.

SP 206 Web Server (WS) 220. A publicly-available Web site that is optionally provided by SPₓ 206.

SP 206 Billing Interface (BI) 222. A single, consolidated interface that SPₓ 206 may use to easily reach, inter alia, one or more external entities such as a credit card or debit card clearinghouse, a carrier billing system, a service bureau that provides access to multiple carrier billing systems, etc.

SP 206 AS 224. Facilities that provide key elements of the instant invention (which will be described below).

It is important to note that while in FIG. 2 the MS 204 WD 212 and MS 204 PC 214 entities are illustrated as being adjacent or otherwise near each other, in actual practice the entities may, for example, be physically located anywhere.

In FIG. 2 the exchanges that are collected under the designation Set 1 represent the activities that might take place as Mary 204 completes a registration process with SPₓ 206:

A) Mary 204 uses one of her PCs 214 to visit SPₓ's 206 WS 220 to, possibly among other things, complete a service registration process (226→228).

B) SPₓ's 206 WS 220 interacts with SPₓ's 206 AS 224 to, possibly among other things, commit some or all of the information that Mary 204 provided to a data repository (e.g., a database), optionally complete a billing transaction, etc. (230).

C) As appropriate and as required a BI 222 completes a billing transaction (232→234).

D) SPₓ's 206 WS 220 responds appropriately (e.g., with the presentation of a confirmation message, etc.) (238→240).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the World Wide Web (WWW via, for example, a Web site that is operated by SPₓ), wireless messaging (SMS, MMS, etc.), Electronic Mail (E-Mail) messages, Instant Messaging (IM), conventional mail, telephone, Interactive Voice Response (IVR) facility, etc.

During the registration process described above a range of information may be captured from a MS including, inter alia:

A) Identifying Information. For example, possibly among other things, name, address, landline and wireless Telephone Numbers (TNs), E-Mail addresses, IM names/identifiers, a unique identifier and a password, etc.

B) Preference Information. For example, information on, possibly inter alia, a MS' travel patterns, concerns, tendencies, etc.

C) Alert Information. For example, triggers, thresholds, classifications, etc. that may, possibly among other things, proscribe the circumstances under which a MS wishes to be alerted to an identified threat.

D) Billing Information. Different service billing models may be offered including, inter alia, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on a MS's phone bill, etc.

E) Other Information. Additional, possibly optional, information.

The specific pieces of information that were described above are illustrative only and it will be readily apparent to one of ordinary skill in the relevant art that numerous other pieces of information (e.g., additional Preference Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SPₓ to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

3) The (electronic, etc.) transfer of funds.

4) The generation of an invoice, statement, etc.

In FIG. 2 the exchanges that are collected under the designation Set 2 represent the activities that might take place as SPₓ's 206 AS 224 dispatches to Mary 204 one or more confirmation E-Mail messages (242→246).

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent the activities that might take place as SPₓ's 206 AS 224 dispatches one or more confirmation SMS, MMS, etc. messages to Mary's 204 WD 212 (248→252) and Mary 204 optionally replies or responds to the message(s) (254→258).

In the instant example the messages are shown traversing a MICV 218.

The SP 206 may employ a Short Code (SC) or a regular TN as its source address (and to which it would ask users of its service to direct any reply messages). While the abbreviated length of a SC (e.g., five digits for a SC administered by Neustar uder the Common Short Code [CSC] program) incrementally enhances the experience of a MS 204 (e.g., the MS 204 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention. For example, possibly inter alia, the registration information that was described above may subsequently be managed (e.g., existing information may be edited or removed, new information may be added, etc.) through any combination of one or more channels including, inter alia, a SP's WWW facility, wireless messaging (SMS, MMS, IMS, etc.), E-Mail messages, IM exchanges, conventional mail, telephone, IVR facilities, etc.

To continue with our hypothetical example . . . a SP may continuously and dynamically receive feeds, input, etc. from, possibly inter alia, one or more CCTV systems. A SP's AS (described in detail below) may, possibly inter alia, process such feeds, input, etc.; using a range of criteria and a suite of techniques, strategies, capabilities, etc. identify candidate threats; and based on among other things configuration, preference, etc. information generate and dispatch an appropriate set of alert (e.g., SMS, MMS, etc.) messages.

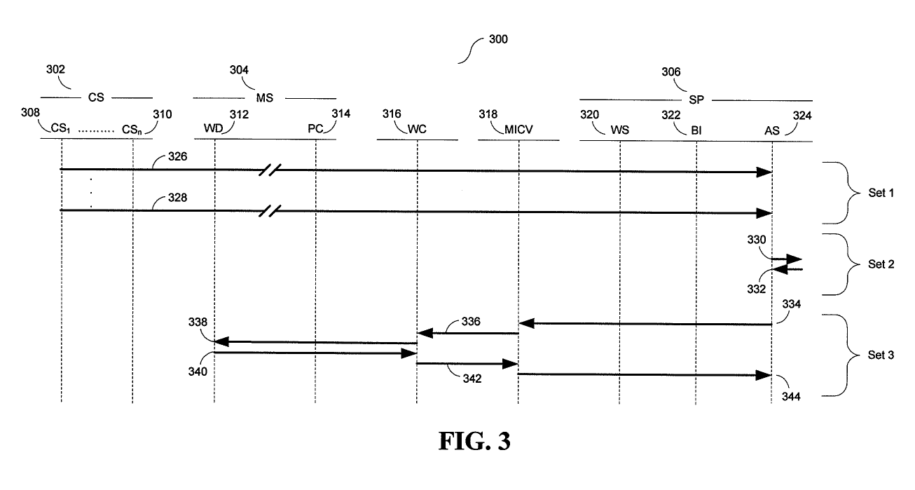

FIG. 3 and reference numeral 300 illustrates various of the exchanges or interactions that might occur under this aspect of our hypothetical example. The entities that are depicted in FIG. 3 are the same as were depicted in, and described for, FIG. 2 with the exception of:

Camera System (CS) 302 CS₁ 308→CSₙ 310. For example, one or more CCTV systems.

In FIG. 3 the exchanges that are collected under the designation Set 1 represent the activities that might take place as the feeds, input, etc. from one or more CSs 302 (e.g., CS₁ 308→CSₙ 310) are passed to, possibly inter alia, a SP's 306 AS 324 (326→328).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, a SP's 306 AS 324 may optionally respond to a CS 302. For example, the feeds, input, etc. may be supplied continuously (e.g., real-time), on a pre-scheduled basis, dynamically on an on-demand basis, etc.

In FIG. 3 the exchanges that are collected under the designation Set 2 represent the activities that might take place as a SP's 306 AS 324 completes a series of processing steps. Among other things those processing steps may leverage any combination of a range of criteria, configuration information, etc.; a suite of techniques, strategies, capabilities, etc.; internal resources (such as, for example, a BI 322, one or more repositories, etc.); and optionally one or more external resources (e.g., via 330→332) to, possibly inter alia, identify candidate threats and generate an appropriate set of alert (e.g., SMS, MMS, etc.) messages.

A SP's AS may employ any combination of a number of automated (e.g., through software solutions) and/or manual (e.g., through human intervention) techniques, strategies, capabilities, etc. as it completes its threat identification activities, including possibly inter alia:

1) Facial recognition systems. For example, observation of facial images may yield specific facial features that, through possibly inter alia a lookup repository, may yield a match.

2) Predictive behavior systems. For example, observation of movements, patterns, etc. may yield specific information that, through possibly inter alia a lookup repository, may yield a match (e.g., a likely next movement, etc.).

3) Data pickup. For example, a Radio Frequency Identification (RFID), Stock Keeping Unit (SKU), etc. pickup or data acquisition from, possibly inter alia, a reader, scanner, etc. may yield information that, through possibly inter alia a lookup repository, may yield a match (e.g., a product, etc. that has been ‘flagged’ as being of interest, etc.).

4) Keys depressed on a telephone, device keyboard, etc. For example, observation of a sequence of keys pressed on a mobile telephone keypad may yield a TN, address, etc. and that information, through possibly inter alia a lookup repository, may yield a match (e.g., a TN that has been ‘flagged’ as being of interest, etc.).

5) Person-to-person interactions, exchanges, etc. For example, observation of an exchange of a package, article, etc. between individuals may yield information that, through possibly inter alia a lookup repository, may yield a match.

6) Lip reading systems. For example, observation of facial images may yield specific lip movements that, in turn, may yield a word, phrase, etc. and that information, through possibly inter alia a lookup repository (that may include, possibly among other things, language conversion capabilities), may yield a match (e.g., a word or phrase that has been ‘flagged’ as being of interest, etc.).

7) Body movement, language, etc. interpretation systems. For example, observation of body movements, posture, etc. may yield information that, through possibly inter alia a lookup repository, may yield a match.

8) Dress analysis. For example, observation of specific clothing, dress, etc. may yield information that, through possibly inter alia a lookup repository, may yield a match (e.g., dress that is inappropriate for a particular climate).

9) Other. For example, manual intervention, injection, override, etc.

The techniques, strategies, capabilities, etc. that were described above are illustrative only and it will be readily apparent to one of ordinary skill in the relevant art that numerous other means (each having, possibly inter alia, its own billing/charging, reporting, access, etc. parameters) are easily possible and indeed are fully within the scope of the present invention.

Various of the techniques, strategies, capabilities, etc. that were described above may leverage one or more internal and/or external repositories such as, possibly inter alia, no-fly lists, registered sex offender lists, conviction and parole lists, the U. S. National Crime Information Center (NCIC), credit reporting agencies, the International Criminal Police Organization (InterPol), product catalogs, telephone directories, Internet search engines, Geographic Information Systems (GISs), news reporting services, archive services, etc.

Each of the techniques, strategies, capabilities, etc. that were described above may have associated with it, possibly inter alia, an optional set of weighting, scoring, confidence, etc. factors that may be used, either individually or together, to identify a match (as identified above) as a threat.

A SP's AS may respond to an identified threat by, possibly inter alia, conditionally generating one or more (SMS, MMS, etc.) alert messages. Alert message generation may be based or conditioned on, possibly inter alia, a body of flexible, extensible, and dynamically updateable configuration information; a set of flexible, extensible, and dynamically updateable rules; information (such as, for example, Preference Information, Alert Information, etc.) that was collected during a registration process; etc. For instance, although the SP's AS may receive streams of imagery from a plurality of cameras, only a subset of those cameras will likely have relevance to a given MS, especially if that MS has provided travel pattern information to the AS. Accordingly, the AS preferably sends alert messages only to MSs who will have an actual interest in such alerts.

Further, when the alert message is an MMS message, the SP's AS may optionally send an image, e.g., the most relevant image, of the apparent threatening behavior so that he MS can further reassess for him/herself the nature of the potential threat.

The catalog of SP AS processing steps that was described above is illustrative only and it will be readily apparent to one of ordinary skill in the relevant art that numerous other processing steps are easily possible and indeed are fully within the scope of the present invention.

In FIG. 3 the exchanges that are collected under the designation Set 3 represent the activities that might take place as a SP's 306 AS 324 dispatches one or more SMS, MMS, etc. alert messages to Mary's 304 WD 312 (334→338) and Mary 304 optionally replies or responds to the message(s) (340→344). In the instant example the messages are shown traversing a MICV 318. The messaging sequence 334→338 and 340→344 may be repeated any number of times.

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention. For example, a SP may offer an inquiry option (having, possibly inter alia, a separate billing/charging component) whereby a MS may submit a request for historical, current, etc. information (including, possibly inter alia, threats, alerts, news, etc.) about an area (as identified by, possibly inter alia, a zip code; an address; a MS' current position as derived from a Location-Based Service [LBS], Global Positioning System [GPS], etc. facility; latitude and longitude coordinates; etc.).

The confirmation, alert, response, etc. message(s) that were described above may optionally contain an informational element—e.g., a relevant or applicable factoid about a specific drug, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current pysical location of the recipient of the message as derived from, as one example, a LBS facility).

The confirmation, alert, response, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation, alert, response, etc. message(s) may optionally contain promotional materials (e.g., still images, video clips, etc.).

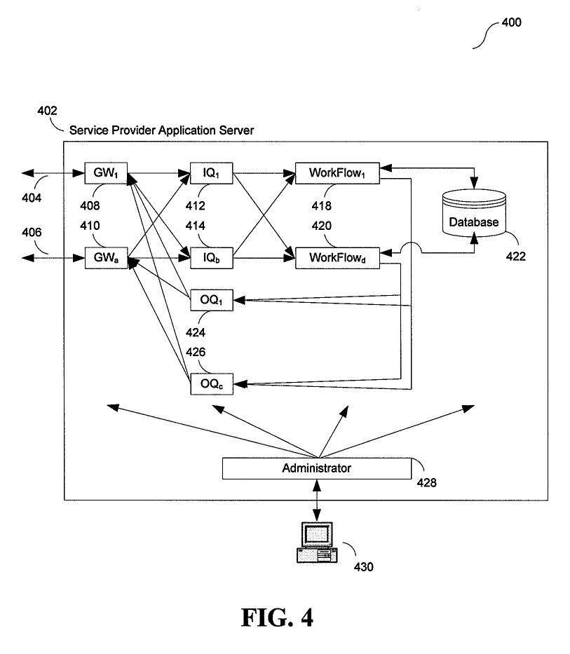

FIG. 4 and reference numeral 400 provides a diagrammatic presentation of aspects of an exemplary SP AS 402. The illustrated AS 402 contains several key components—Gateways (GW₁ 408→GWₐ 410 in the diagram), Incoming Queues (IQ₁ 412→IQ_{b} 414 in the diagram), WorkFlows (WorkFlow₁ 418→WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in the diagram) handle incoming (SMS/MMS/etc. messaging, CS, etc.) traffic 404→406 and outgoing (SMS/MMS/etc. messaging, CS, etc.) traffic 404→406. Incoming traffic 404→406 is accepted and deposited on an intermediate or temporary Incoming Queue (IQ₁ 412→IQ_{b} 414 in the diagram) for subsequent processing. Processed artifacts are removed from an intermediate or temporary Outgoing Queue (OQ₁ 424→OQ_{c} 426 in the diagram) and then dispatched 404→406.

A dynamically updateable set of one or more Incoming Queues (IQ₁ 412→IQ_{b} 414 in the diagram) and a dynamically updateable set of one or more Outgoing Queues (OQ₁ 424→OQ_{c} 426 in the diagram) operate as intermediate or temporary buffers for incoming 404→406 and outgoing traffic 404→406.

A dynamically updateable set of one or more WorkFlows (WorkFlow₁ 418→WorkFlow_{d} 420 in the diagram) or WorkFlow modules remove incoming traffic 404→406 from an intermediate or temporary Incoming Queue (IQ₁ 412→IQ_{b} 414 in the diagram), perform all of the required processing operations, and deposit processed artifacts on an intermediate or temporary Outgoing Queue (OQ₁ 424→OQ_{c} 426 in the diagram). The WorkFlow component will be described more fully below.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 428 that is depicted in FIG. 4 provides management or administrative control over all of the different components of an AS 402 through, as one example, a Web-based interface 430. It will be readily apparent to one of ordinary skill in the relevant art that numerous other interfaces (e.g., a data feed, etc.) are easily possible.

Through flexible, extensible, and dynamically updatable configuration information a WorkFlow component may be quickly and easily realized to support any number of activities. For example, WorkFlows might be configured to support a registration process; to support interactions with CS and other monitoring, etc. facilities; to support various internal processing steps including, possibly inter alia, (1) the identification of threats and (2) the generation and dispatch of alert messages; to support the generation and dispatch of confirmation, response, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support scheduled (e.g., daily, weekly, etc.) and/or on-demand reporting with report results delivered (to, for example, a MS) through SMS, MMS, etc. messages; through E-Mail; through a Web-based facility; etc.

While aspects of the discussion that was presented above focused on the use of CSs such as CCTV facilities it will be readily apparent to one of ordinary skill in the relevant art that other mechanisms (such as, for example, Closed Circuit Digital Photography [CCDP]; megapixel CCDP; air quality, contamination, etc. sensors; electronic communication sensors; etc.) are equally applicable and, indeed, are fully within the scope of the present invention.

It is important to note that while aspects of the discussion that was presented above focused on the use of SCs it will be readily apparent to one of ordinary skill in the relevant art that TNs and other message address identifiers are equally applicable and, indeed, are fully within the scope of the present invention.

The discussion that was just presented referenced two specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms (such as, for example, Internet Protocol [IP] Multimedia Subsystem [IMS], IM, E-Mail, etc.) are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| BI | Billing Interface |
| CCDP | Closed Circuit Digital Photography |
| CCTV | Closed Circuit Television |
| CS | Camera System |
| CSC | Common Short Code |
| DBMS | Database Management System |
| E-Mail | Electronic Mail |
| GIS | Geographic Information System |
| GPS | Global Positioning System |
| GW | Gateway |
| IM | Instant Messaging |
| IMS | IP Multimedia Subsystem |
| IP | Internet Protocol |
| IQ | Incoming Queue |
| IVR | Interactive Voice Response |
| LBS | Location-Based Service |
| MICV | Messaging Inter-Carrier Vendor |
| MMS | Multimedia Message Service |
| MS | Mobile Subscriber |
| NCIC | National Crime Information Center |
| ODBMS | Object Database Management System |
| OQ | Outgoing Queue |
| PC | Personal Computer |
| RDBMS | Relational Database Management System |
| RFID | Radio Frequency Identification |
| SC | Short Code |
| SKU | Stock Keeping Unit |
| SMS | Short Message Service |
| SP | Service Provider |
| TN | Telephone Number |
| WC | Wireless Carrier |
| WD | Wireless Device |
| WS | Web Server |
| WWW | World-Wide Web |

What is claimed is:

1. A method for threat alerting, comprising:
receiving data from one or more sensors;
performing one or more processing steps on said data, using at least in part one or more identification techniques and information previously supplied by a mobile subscriber, yielding candidate threats;
generating an alert message in view of said candidate threats; and
dispatching said alert message to a wireless device of said mobile subscriber.

2. The method of claim 1, wherein said identification techniques include at least one of facial recognition, external data capture, predictive behavior, lip reading analysis, body language interpretation, and dress analysis.

3. The method of claim 1, wherein said information is defined by a mobile subscriber during a registration process.

4. The method of claim 3, wherein said information includes at least one of Identifying Information, Preference Information, Alert Information, and Billing Information.

5. The method of claim 3, wherein said information is preserved through a User Profile.

6. The method of claim 3, wherein said registration process is Web-based.

7. The method of claim 3, wherein said registration process includes a billing component.

8. The method of claim 1, wherein said alert message is a SMS message.

9. The method of claim 1, wherein said alert message is a MMS message.

10. The method of claim 1, wherein said alert message contains advertising and/or promotional material.

11. The method of claim 1, further comprising:
charging a fee for said threat alerting.

12. A method for threat alerting, comprising:
receiving from a mobile subscriber travel pattern information for the mobile subscriber;
receiving a stream of images from a camera;
determining that the images from the camera depict a location that is within the travel pattern of the mobile subscriber;
processing the images from the camera to determine the existence of threatening behavior at the location; and
sending an alert message to the mobile subscriber indicating that a threat may exist at the location.

13. The method of claim 12, wherein the stream of images is received from a closed circuit television system.

14. The method of claim 12, wherein processing the images from the camera comprises at least one of facial recognition, person-to-person interaction, body movement, or dress analysis.

15. The method of claim 14, further comprising weighting values representative of the at least one of facial recognition, person-to-person interaction, body movement, or dress analysis.

16. The method of claim 12, wherein processing the images from the camera comprises identifying that a given key or string of keys has been selected.

17. The method of claim 12, further comprising collecting data associated with items within the images from the camera.

18. The method of claim 17, wherein the data is radio frequency identification (RFIF) data.

19. The method of claim 12, further comprising receiving a reply message from the mobile subscriber in response to the alert message.

20. A system for threat alerting, comprising:
a gateway at which incoming data is received from one or more sensors;
a plurality workflow modules, said workflow modules being operable to:
(a) extract one or more data elements from said incoming data yielding extracted data elements;
(b) perform one or more processing steps on said extracted data elements, using at least in part one or more identification techniques and information previously supplied by a mobile subscriber, yielding candidate threats;
(c) generate one or more alert message, said alert messages based on aspects of said candidate threats; and
a gateway at which said alert messages are dispatched to a wireless device of said mobile subscriber.

21. The system of claim 20, wherein said identification techniques include at least one of facial recognition, external data capture, predictive behavior, lip reading analysis, body language interpretation, and dress analysis.

22. The system of claim 20, wherein said information is defined by a mobile subscriber during a registration process.

23. The system of claim 22, wherein said information includes at least one of Identifying Information, Preference Information, Alert Information, and Billing Information.

24. The system of claim 22, wherein said information is preserved through a User Profile.

25. The system of claim 22, wherein said registration process is Web-based.

26. The system of claim 22, wherein said registration process includes a billing component.

27. The system of claim 20, wherein said alert message is a SMS message.

28. The system of claim 20, wherein said alert message is a MMS message that includes an image that represents said candidate threats.

29. The system of claim 20, wherein said alert message contains advertising and/or promotional material.
